(19) United States
(12) Patent Application Publication
(10) Pub. No.: US 2009/0089628 A1
(43) Pub. Date: Apr. 2, 2009

(54) FILE SYSTEM ERROR DETECTION AND RECOVERY FRAMEWORK

(76) Inventors: Mark S. Day, Saratoga, CA (US); Dominic B. Giampaolo, Mountain View, CA (US); Puja D. Gupta, Sunnyvale, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 11/865,352

(22) Filed: Oct. 1, 2007

(51) Int. Cl. G06F 11/07

(52) U.S. Cl. 714/54; 714/E11.021

(57) ABSTRACT

Methods, systems and machine readable media for file system error detection and protection are described. In one aspect, an embodiment of a method includes collecting first data identifying at least one error in performing at least one of reading or writing data to a storage device and determining, through an association between the first data and file identifiers, a set of files which are effected by the at least one error. The collecting may be performed automatically as a background process. In another aspect, an embodiment of a method includes detecting at least one error in file system metadata for a storage device, the detecting being performed automatically as a background process, and storing state information automatically in response to the detecting; the state information indicates that upon next mounting of the storage device, the data processing system will automatically cause the running of a file system check of the file system metadata.

### BACKGROUND

Data processing systems, such as computer systems, often use file systems to store files and other data, such as a user's files, on a storage device, such as a hard disk or flash memory or other devices. A file system is designed to allow the creation, storage and retrieval of files, and other data, from the storage device. Further information about file systems can be found in the book Practical File System Design with the Be File System, by Dominic Giampaolo. A file system typically stores metadata which maps an identifier for each file to physical addresses on the storage device which store the data of the file; this enables the file system to retrieve the file from or store the file to the storage device. If the metadata for the file system becomes corrupt, the file system may be unable to perform its functions for some or all of the files managed by the file system. The file system can become corrupt due to hardware failures in the storage device (e.g. a block becomes defective) or from other failures (e.g. a software crash).

Modern hard drives and other storage devices are generally reliable, but they can fail and cause problems with storing or reading and writing data to the storage device. For example, a block which becomes defective on a hard disk will produce input/output (I/O) errors when reading from or writing to the bad block.

There are a variety of solutions which attempt to deal with corruption of file system metadata and/or defective blocks (or other I/O errors) of a storage device. One type of solution uses dedicated software, such as Norton disk recovery and management software, to detect problems (e.g. corruption in file system metadata) and attempt to correct the problems. The Unix command “fsck” is another example of a program which attempts to detect and correct a corruption in the file system metadata. This type of solution requires a user to initiate the use of the recovery software; this is typically done after a failure has caused a noticeable difference in the operation of the data processing system. Another type of solution uses disk management software to identify and avoid the use of defective disk blocks. Certain file systems are designed to provide correction and recovery mechanisms through the use of checksumming and disk scrubbing; ZFS from OpenSolaris.org is one example of this type of file system. ZFS can detect an error through checksumming. In ZFS, all data is read to detect latent errors as part of a disk scrubbing process; a scrub traverses the storage to read every copy of every block, validate it against its 256-bit checksum and repair it if necessary. All this happens while the storage pool is live and in use. Another type of solution provides a message to a user when a system and a storage device has experienced a hot unplug (e.g. the user has disconnected the storage device from the system without properly unmounting/ejecting the storage device from the system).

### SUMMARY OF THE DESCRIPTION

Methods, systems and machine readable media for file system error detection and protection are described.

In one aspect of this disclosure, an embodiment of a method for operating a data processing system includes collecting first data identifying at least one error in performing at least one of reading or writing data to a storage device and determining, through an association between the first data and file identifiers, a set of files which are effected by the at least one error. The collecting of the first data, in one implementation, can be performed automatically (e.g. initiated by the system rather than the user) as a background process by a kernel, or other component, of an operating system of the data processing system while the data processing system is being operated by a user. The first data can specify at least one of addresses and blocks associated with physical media of the storage device. The determining of the set of files, in one embodiment, can determine one or more file names specified by a user so that, if desired, those file names can be displayed in a user interface, or otherwise presented to a user along with a message indicating that an error occurred when reading or writing data for those file names. The determining of the set of files can also be initiated and performed automatically (e.g. without user interaction or initiation) by the data processing system in response to the collecting of the first data, and the presenting of a user interface, which can present user specified file names along with a message indicating that an error occurred when reading or writing data for those file names, can also be initiated and performed automatically (e.g. without user interaction or initiation) by the data processing system. In one embodiment, the method can also include recording the first data and the file names specified by a user in a log which is capable of storing a plurality of the errors, and the method can also include presenting those file names in response to a user request or in response to determining that a certain number of errors have accumulated in the log. In one embodiment, the user interface can include a preference user interface to allow a user to specify options for how the errors and file names are presented to the user; for example, in one embodiment, the options can allow a user to receive messages about only user created files (e.g. those created and named by a user) rather than system files (e.g. index files for a system wide search engine such as Spotlight) or to receive messages about all files and other data or to receive messages about a subset of all files or to receive messages after a certain number of errors have been accumulated, or to include more information, beyond file names, when the messages are presented. This more information can include one or more of error type (e.g. read or write), physical block number, logical block number, device node, file pathname (e.g./Volume/Users/Jim/WeatherInfo/dopplerradar.pdf), mount point, type of file system (e.g. HFS+), type of file (e.g. system or user, etc.) and volume unique identifier (UID). In one embodiment, the method may be implemented whenever a user level or system level process initiates a read or write operation (e.g. the user causes a saving of a newly created file or a modified file or the system initiates the saving or reading of a file), and this implementation may be characterized as a runtime execution of the method; in another embodiment, the method may be implemented both (a) whenever a user level or system level process initiates a read or write operation and (b) whenever a background daemon process, which operates independently of any user level or system level process, attempts to text reading or writing of data to the storage device. The various embodiments of this method may be implemented by a data processing system which executes software stored on a machine readable medium, and these embodiments may be implemented by at least an operating system component and a file system software component. The file system software component can be configured to maintain an association (e.g. a mapping) between the first data, which can specify portions of physical media of a storage device and file identifiers of files having file names specifiable by a user; the operating system (OS) component, which may be an OS kernel which schedules system processes and user application processes, can be configured to collect the first data.

In another aspect of this disclosure, an embodiment of a method for operating a data processing system includes detecting at least one error in file system metadata for a storage device, the detecting being performed automatically while the data processing system is capable of allowing a user to cause execution of at least one user application process, and storing state information automatically in response to the detecting of the at least one error, wherein the state information specifies that upon next mounting of the storage device, the data processing system will automatically (e.g. without user interaction or initiation) cause the running of a file system check of the file system metadata. This state information, in one embodiment, forces a file system check, such as a check which results from running the Unix command “fsck,” upon the next mounting of the storage device. The storing of state information, in one embodiment, can include marking a volume which has files described by the file system metadata, and this marking indicates that there is the at least one error and hence the file system metadata is corrupt. The detecting can occur at runtime of the data processing system, and during runtime, one or more files are capable of being modified, and are often modified, and the file system metadata is capable of being modified in response to modifying the file. The file system check includes, in one embodiment, a check of at least consistency of the file system metadata, and in one embodiment, the file system check can be performed on the storage device which is a boot volume of the data processing system. In one embodiment, the detecting can be performed by one of a file system software component or an operating system software kernel. In one embodiment, the method can further include verifying, on the next mounting of the storage device, whether the file system metadata needs to be corrected and if it does, attempting to correct the file system metadata. In one embodiment, the method can further include mounting the storage device in a read only mode if the attempting to correct the file system metadata fails.

Other methods are described, and systems and machine readable media which perform these methods are described.

### BRIEF DESCRIPTION OF THE DRAWINGS

The present invention is illustrated by way of example and not limitation in the figures of the accompanying drawings in which like references indicate similar elements.

FIG. 1 is a block diagram of an example of a data processing system such as a general purpose or special purpose computer system or other types of electronic devices.

FIG. 2 shows an example of a software architecture for implementing at least certain embodiments described herein.

FIG. 3 shows an example of a data structure of file system metadata; this example shows an association or mapping between physical locations on physical media of a storage device and file identifiers of files managed by a file system software component.

FIG. 4 is a flowchart which shows an example of one method according to one aspect of this disclosure.

FIG. 5 is a flowchart which shows another example of a method according to another aspect of this disclosure.

FIGS. 6A, 6B, and 6C show examples of user interfaces for presenting messages to one or more users according to at least certain embodiments described herein.

FIG. 7 shows an example of a user interface for presenting messages to one or more users according to at least certain embodiments described herein.

### DETAILED DESCRIPTION

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a through understanding of various embodiments of the present invention. However, in certain instances, well-known or conventional details are not described in order to provide a concise discussion of embodiments of the present inventions.

The present description includes material protected by copyrights, such as illustrations of graphical user interface images. The owners of the copyrights, including the assignee of the present invention, hereby reserve their rights, including copyright, in these materials. The copyright owner has no objection to the facsimile reproduction by anyone of the patent document or the patent disclosure, as it appears in the Patent and Trademark Office file or records, but otherwise reserves all copyrights whatsoever. Copyright Apple Inc. 2007.

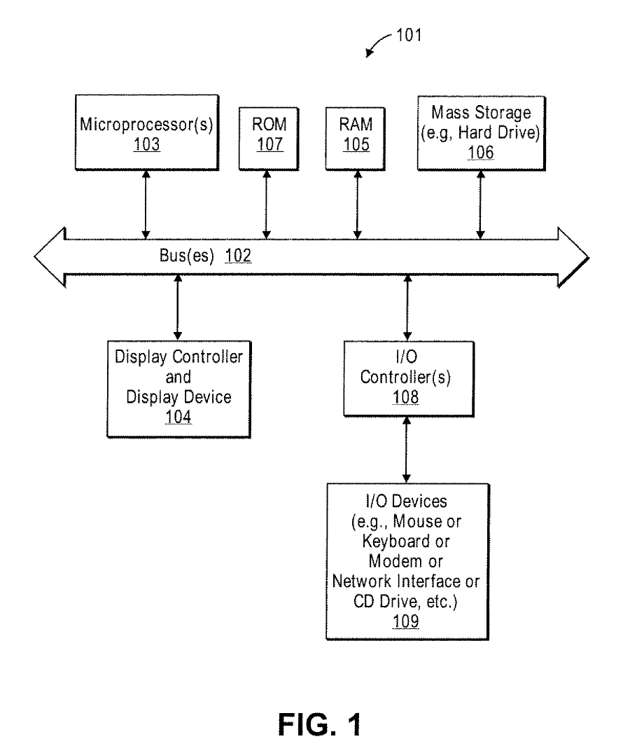

FIG. 1 shows one example of a typical data processing system such as a computer system which may be used with the various embodiments of the present invention. Note that while FIG. 1 illustrates various components of a computer system, it is not intended to represent any particular architecture or manner of interconnecting the components as such details are not germane to the present invention. It will also be appreciated that network computers, cellular telephones, personal digital assistants (PDAs), entertainment devices, consumer electronic devices and other data processing systems which have fewer components or perhaps more components may also be used with the present invention. The computer system of FIG. 1 may, for example, be a Macintosh computer from Apple Inc.

As shown in FIG. 1, the computer system 101, which is a form of a data processing system, includes a bus 102 which is coupled to a microprocessor(s) 103 and a ROM (Read Only Memory) 107 and volatile RAM 105 and a non-volatile memory 106. The microprocessor 103 may, for example, be a microprocessor from Intel or Motorola, Inc. or IBM. The bus 102 interconnects these various components together and also interconnects these components 103, 107, 105, and 106 to a display controller and display device 104 and to peripheral devices such as input/output (I/O) devices which may be mice, keyboards, modems, network interfaces, printers and other devices which are well known in the art. Typically, the input/output devices 109 are coupled to the system through input/output controllers 108. The volatile RAM (Random Access Memory) 105 is typically implemented as dynamic RAM (DRAM) which requires power continually in order to refresh or maintain the data in the memory. The mass storage 106 is typically a magnetic hard drive or a magnetic optical drive or an optical drive or a DVD RAM or flash memory or other types of memory systems which maintain data (e.g. large amounts of data) even after power is removed from the system. Typically, the mass storage 106 will also be a random access memory although this is not required. While FIG. 1 shows that the mass storage 106 is a local device coupled directly to the rest of the components in the data processing system, it will be appreciated that the present invention may utilize a non-volatile memory which is remote from the system, such as a network storage device which is coupled to the data processing system through a network interface such as a modem or Ethernet interface. The bus 102 may include one or more buses connected to each other through various bridges, controllers and/or adapters as is well known in the art. In one embodiment the I/O controller 108 includes a USB (Universal Serial Bus) adapter for controlling USB peripherals and an IEEE 1394 controller for IEEE 1394 compliant peripherals.

It will be apparent from this description that aspects of the present invention may be embodied, at least in part, in software. That is, the techniques may be carried out in a computer system or other data processing system in response to its processors, such as a microprocessor, executing sequences of instructions contained in a memory, such as ROM 107, RAM 105, mass storage 106 or a remote storage device. In various embodiments, hardwired circuitry may be used in combination with software instructions to implement the present invention. Thus, the techniques are not limited to any specific combination of hardware circuitry and software nor to any particular source for the instructions executed by the data processing system. In addition, throughout this description, various functions and operations are described as being performed by or caused by software code to simplify description. However, those skilled in the art will recognize what is meant by such expressions is that the functions result from execution of the code by a processor, such as the microprocessor 103.

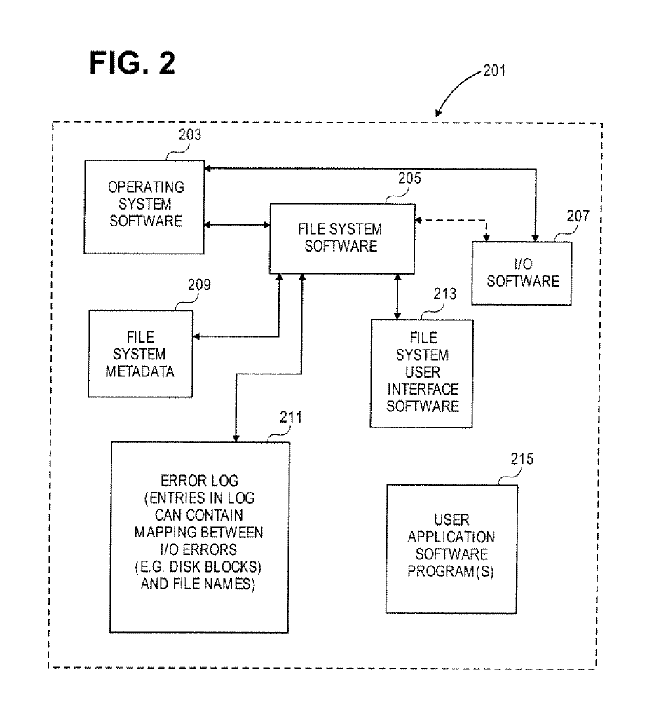

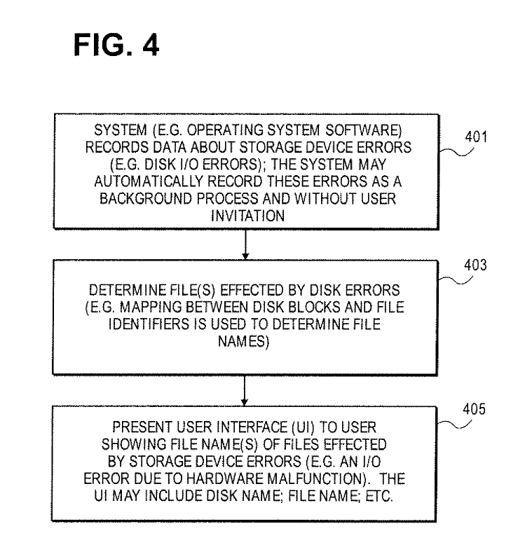

FIG. 2 shows an example of a software component architecture 201 which may be used in at least certain of the embodiments disclosed herein. The software architecture includes both executable software and data, such as the file system metadata 209 and the error log 211, and can perform one or more of the methods described herein, such as the methods shown in FIGS. 4 and/or 5. The software and the data of the architecture shown in FIG. 2 may be stored in a memory which can be one or more of the RAM 105, ROM 107, and the mass storage 106 or other combinations of storage devices. In a typical implementation, much of the executable software which is currently being executed by a data processing system is often stored in the RAM 105, and much of the data, such as the file system metadata 209 and the error log 211, can be stored in the mass storage 106 shown in FIG. 1. The operating system software 203 may be one of a variety of different types of operating systems, such as the Macintosh OS or the Windows OS (operating system) or a Linux OS, etc. In at least certain embodiments, the operating system software 203 schedules tasks for both the system and user application processes and controls hardware and allows access to the hardware for other software components. For example, the file system software 205 and the user application software programs 215 may need access to the hardware which, in at least certain embodiments, is provided through calls to the operating system software 203. These calls, as well as other mechanisms, may be used to operatively couple the operating system software 203 to other software components, such as the file system software 205, the file system user interface software 213, the input/output (I/O) software 207, and the one or more user application software programs 215. The file system software 205 provides a file system for the data processing system which may use the software architecture 201 shown in FIG. 2. The file system software 205 manages access to files and data on one or more storage devices and maintains information, such as the file system metadata 209 which is used to manage the access to the files and data. The file system metadata 209 may include, in a typical embodiment, metadata for (a) a file which identifies free and/or allocated blocks on a storage medium; (b) data describing the structure of file directories on a storage medium or storage device; (c) data describing each file (e.g. addresses of the blocks of the storage media which contain the data of a file; user and group ownership of the file; access mode, such as read, write, and execute permission; the size of the file; access and modification times; etc.). The file system software 205 may be, for example, the file system software within Macintosh OS X. The file system software 205 may, in at least certain embodiments, create an error log based upon the method shown in FIG. 4. This error log may be error log 211 which contains entries mapping or associating I/O errors and file names, such as user specified file names for user created files.

The software architecture shown in FIG. 2 may also include a file system user interface software 213, such as the Finder which operates on the Macintosh operating system. In at least certain embodiments, the file system user interface software 213 provides views of files and other data in a file system, and allows copying, moving (e.g. between subdirectories or folders), deleting, and creating of files. The files may be created in user applications, such as the user application software programs 215, and then further manipulated (e.g. copying, moving, deleting, etc.) in the file system user software 213. The user application software programs 215 may include word processing programs, spreadsheet programs, web browsing programs, and other programs. In each case, these application software programs are operatively coupled to the operating system software 203 and the file system software 205 as well as other software components in at least certain embodiments. The I/O software 207 may be software which provides drivers and other software for communication between peripherals, such as a storage device which may be a disk drive or flash memory, and the rest of the system. The I/O software 207 is operatively coupled to at least the operating system software 203 and optionally coupled to other software components such as the file system software 205 in at least certain embodiments.

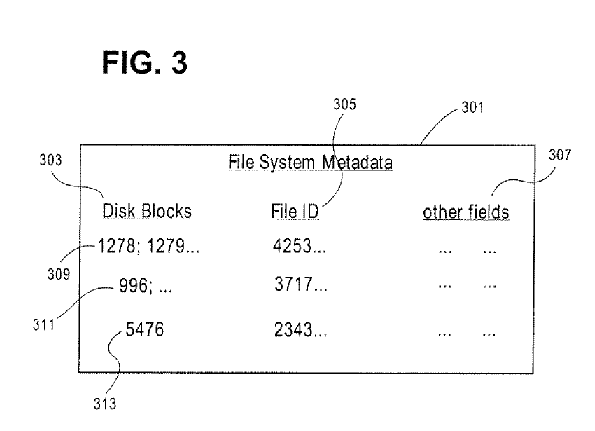

FIG. 3 shows an example of the file system metadata 209. The data structure 301 may include a variety of different fields, such as the disk block field 303, the file identifier (ID) field 305, and other fields 307. Each row of data, such as rows 309, 311, and 313, represent different files managed by the file system software. For each file, there may be a file identifier, which may be a unique identifier for each file or may be a file name which is specified by either the system or the user, or other types of identifiers. For each file, the metadata, in one embodiment, includes the file identifier and other fields and also includes metadata indicating the physical or logical address in the storage medium which contains the files, such as the disk blocks on a hard drive. The association or mapping between the file identifier for a file and the disk blocks for the file allows the file system software to store and retrieve the file, which storage or retrieval is typically in response to requests from the user or the system either through the file system user interface software 213 or the user application software programs 215. In certain embodiments, access to the files may also be required by system software or initiated by system software, such as search engine software which needs to index a file or perform other operations on a file; an example of such software is the Spotlight software which runs on Macintosh OS 10.4. The data structure 301 may be used to provide the association or mapping used in operation 403 in the method of FIG. 4 which will now be described.

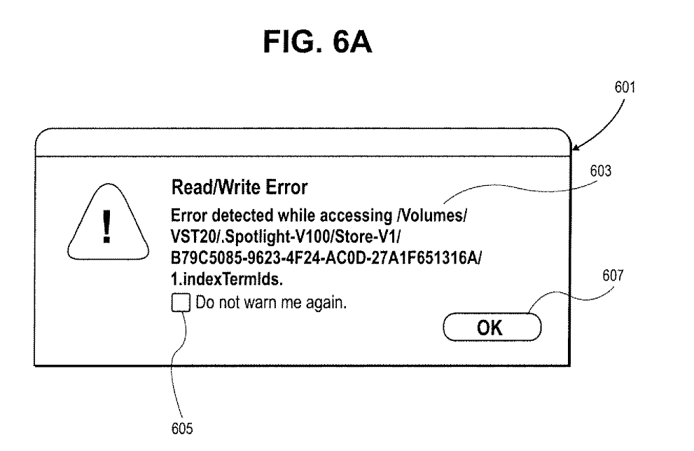

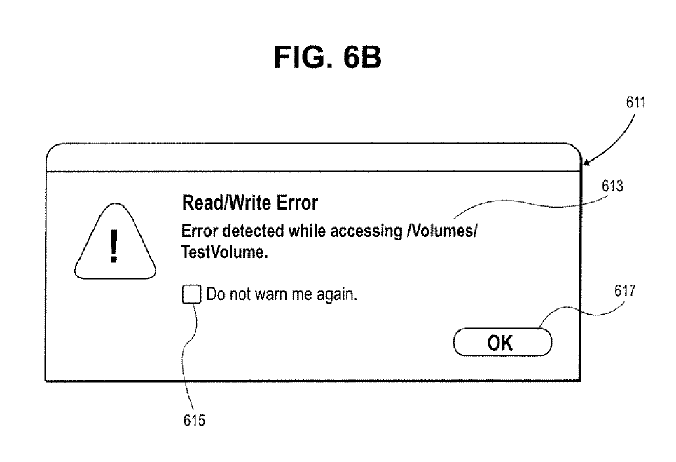

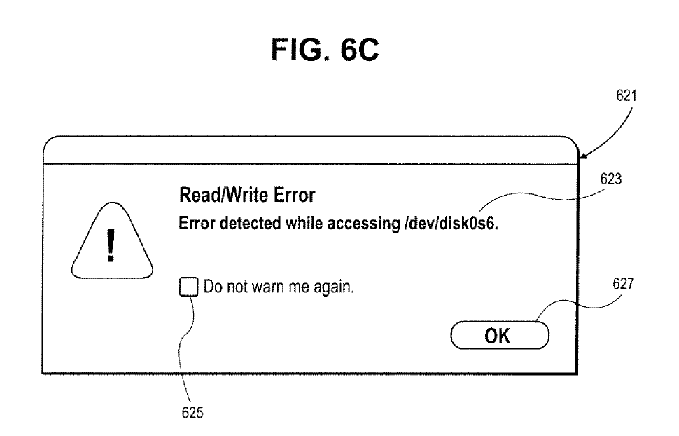

FIG. 4 shows one example of a method of providing the capability of presenting, to a user, the file names for files affected by I/O errors or other storage device errors. In operation 401, the system, such as the operating system software, records data about storage device errors. These may be disk I/O errors which occur when a file is read from the storage device or when the file is written to the storage device. These I/O errors are typically due to a physically damaged disk, such as a bad block on the disk drive. The system may automatically record these errors without any user request or user initiation. In other words, the system may record these errors without user request and without any initiation for the process of recording the errors from the user. Further, the system may perform this recording as a background process even when files are not being accessed by the user or by the system. Hence, the storage device errors can be collected, in at least one embodiment, automatically in a process which is initiated by the system rather than by the user, and further they may be collected as a background process by a software component, such as the kernel of an operating system software or other components of an operating system. These errors may be recorded while the data processing system is being operated by a user. The data about these errors can specify at least one of addresses or blocks associated with the physical media of one or more storage devices. In operation 403, the system determines the files affected by the disk errors collected by operation 401. In one embodiment, the determining of the files in operation 403 may include determining one or more file names specified by a user (or the system) so that, if desired, those file names can be displayed or otherwise presented in a user interface to a user along with a message indicating that at least an error occurred when reading or writing data for those file names. The determining in operation 403 typically involves using a mapping or association between disk blocks and file identifiers in at least certain embodiments. FIG. 3 shows an example of a data structure which may be used to perform this mapping between disk blocks and file identifiers. In the case where the file identifiers are unique identifiers assigned by the system to each file, rather than a user specified file name (such as /Volume/Users/Jim/WeatherInfo/dopplerradar.pdf) then, the file system metadata will also include the user specified or system specified file name which is associated with the particular file identifier. Operation 405 is, in at least certain embodiments, an optional operation in which a user interface is presented to a user showing the file names of the files affected by the storage device errors. This user interface may include additional information, such as disk name, physical block number, logical block number, device node, full file pathname, mount point, type of file system, type of file, etc. FIGS. 6A, 6B, and 6C show examples of a user interface for presenting file names and/or other information associated with a storage device error. These exemplary user interfaces are further described below. Operation 405 may further include an optional parsing of a message from the file system to create the user interface message for presentation by a file system user interface software, such as the file system user interface software 213.

FIG. 6A shows an example of a user interface in which the system has detected that there was an error in reading or writing to a given file on the storage device. The user interface 601 includes a message indicating the type of error, in this case a read/write error, and the message specifies the name of the file 603 which may be a user or system specified name for the file. This message allows a user to take note of the file name and to take any action deemed necessary or desirable, such as examining the file, backing up the file, using an archival copy of the file, attempting to repair the file, etc. The user interface shown in FIG. 6A also includes a check box 605 which allows a user to turn on or turn off the warning mechanism or message; in one embodiment, when the check box is selected, the system will not warn the user about any read/write error obtained through the method shown in FIG. 4. In an alternative embodiment, the system will stop warning or providing the message for the particular file or files shown in the message. The user interface 601 also includes an Ok button 607 which allows the user to close the message presented by the user interface 601 and thereby remove it from presentation on a display device of a data processing system. It will be appreciated that alternative messages may include additional files or a Save button to allow the user to save the message or a scrolling list for scrolling through file names in a current message, or for a certain number of prior messages as well as the current message, etc. In certain embodiments, the data processing system may present to the user a preference panel or preference setting window which allows the user to set options or preferences indicating how the messages are to be presented to the user. For example, the system may allow the user to select an option in which no messages are presented or in which messages about only user created files (e.g. those created and named by a user) are presented or to present messages about all files or about a subset of files and data or to present messages only after a certain number of messages have been accumulated in an error log, or to include more information, beyond file names, when the messages are presented, etc. In one embodiment, the preference may, by default, be set such that names of all files are displayed in a message, such as the message shown in FIG. 6A, which would include Spotlight indexes, individual files in bundles or packages, files not browsable by the Finder or other file system user interface software, etc. The user interface 611 shown in FIG. 6B is an example of another user interface displayed on a display device in response to a storage device error. In this case, the system does not have access to the name of the file (e.g. the file system metadata has been corrupted) but does have access to the name of the volume or storage device, which is presented as name 613. The user interface 611 also includes a check box 615 which may be similar to the check box 605, and an Ok button 617 which may similar to the Ok button 607. FIG. 6C shows another example of a user interface, in this case user interface 621, for presenting information about a storage device error. In this case, the system does not have access to the name of the file and the name of the volume, but does have access to the BSD name of the device. The name of the device is shown as name 623 in the user interface 621, which also includes a check box 625 which may be similar to the check box 605 and further includes the Ok button 627 which may be similar to the Ok button 607.

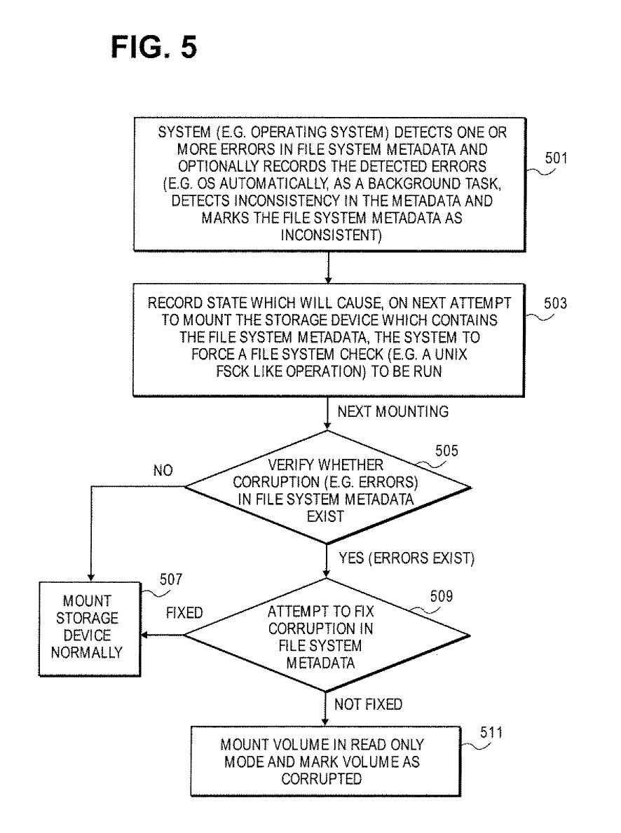

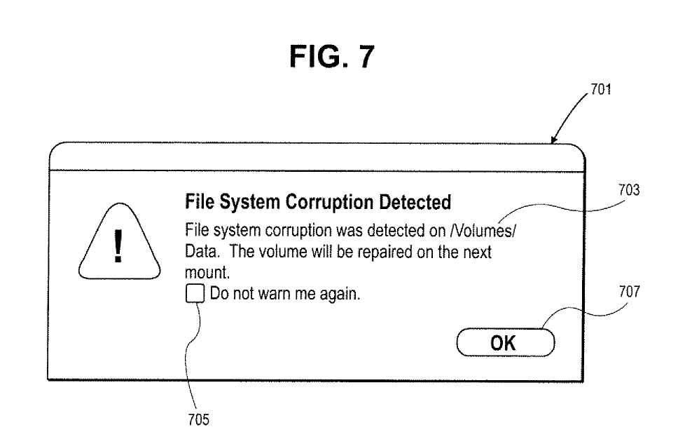

Another aspect of this disclosure relates to methods, systems and machine readable media for detecting file system metadata corruption and for setting the state of the data processing system such that, when the storage device having the detected corruption of the file system metadata is next mounted by the data processing system, the system will force a file system check to be performed on the storage device which contains the corrupted file system metadata. FIG. 5 shows an example of a method according to this aspect. In operation 501, the system, such as the operating system, detects one or more errors in the file system metadata and optionally records the detected errors. For example, the operating system may automatically, without request from the user and without user initiation for the process, detect an inconsistency in the metadata and in response to this detection, mark the file system metadata as inconsistent or otherwise corrupt. This operation may be performed at runtime while the file system metadata is being accessed in response to a system process or in response to a user application process, or it may be performed as a background task in which the file system metadata is being checked even though no user application process has initiated access to the file system metadata and no system process, other than this background process, has requested access to the file system metadata. Operation 503 is performed in response to detecting the corrupted file system metadata which may be performed as shown in operation 501. In operation 503, the system records a state or state information which will cause, on the next attempt to mount the storage volume which contains the file system metadata, the system to force a file system check, such as a Unix fsck-like operation to be run on the system to check the file system metadata. In one embodiment, operation 503 occurs automatically, without user request or initiation, in response to operation 501. The user may be given an opportunity to decline this operation in certain embodiments, while in other embodiments, the system merely alerts the user that a file system check will be performed on the next mounting. FIG. 7 shows an example of a user interface 701 in which an alert is displayed to the user indicating that file system corruption has been detected and the volume will be checked and repaired on the next mounting. The message in the user interface 701 includes a volume name 703 which contains the corrupted file system metadata. This allows the user to identify a particular volume, which may be the boot volume of the data processing system which has been affected by the corrupted file system metadata. The user interface 701 also includes a check box 705; in one embodiment, this check box, when checked, will cause the system to not warn the user about the detection of file system corruption and to not alert the user that mounting of the volume the next time may take longer due to the file system check which is to be performed on the storage device or volume. The Ok button 707 allows the user to dismiss or otherwise cause the user interface 701 to disappear or be removed from the display device. Operation 505 indicates what happens upon next mounting of the storage device. In this operation, the file system metadata is checked again for corruption, such as errors. If no errors exist, then the storage device is mounted normally in operation 507. If errors do exist, then operation 509 is performed in which it is attempted to fix the corruption in the file system metadata. This operation 509 may be performed on a boot volume following operations 503 and 505. This operation 509 may be similar to the operations performed when the Unix command “fsck” is executed to attempt to repair corruption in file system metadata. If the corruption is fixed, then operation 507 is performed to mount the storage device normally. On the other hand, if the corruption is not fixed, then, in at least certain embodiments, the volume or storage device is mounted in operation 511 in read only mode and the volume is marked as corrupted. The mounting in read only mode allows a user to safely retrieve data, such as user files, from the corrupted volume. In at least certain embodiments, the state or state information recorded in operation 503 may be stored in the log 211 or in other data structures designed to hold system information about storage devices.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A machine readable medium storing executable program instructions which cause a data processing system to perform a method comprising:
collecting first data identifying at least one error in performing at least one of reading or writing data to a storage device;
determining, though an association between the first data and file identifier, a set of files which are effected by the at least one error.

2. The medium as in claim 1 wherein the collecting is performed automatically as a background process by a kernel of an operating system of the data processing system while the data processing system is being operated by a user and wherein the first data specifies at least one of addresses and blocks associated with physical media of the storage device and wherein the determining determines one or more file names specified by a user.

3. The medium as in claim 2 wherein the method further comprises:
recording the first data and the file names in a log which is capable of storing a plurality of the errors.

4. The medium as in claim 3 wherein the method further comprises:
presenting a user interface which is configured to present the file names to a user.

5. The medium as in claim 4 wherein the presenting is in response to at least one of (a) a user request or (b) an accumulation of a certain number of errors in the log.

6. The medium as in claim 3 wherein the user interface comprises a preference interface to allow a user to specify options for how the errors are presented.

7. A machine implemented method comprising:
collecting first data identifying at least one error in performing at least one of reading or writing data to a storage device;
determining, though an association between the first data and file identifier, a set of files which are effected by the at least one error.

8. The method as in claim 7 wherein the collecting is performed automatically as a background process by a kernel of an operating system of the data processing system while the data processing system is being operated by a user and wherein the first data specifies at least one of addresses and blocks associated with physical media of the storage device and wherein the determining determines one or more file names specified by a user.

9. The method as in claim 8 wherein the method further comprises:
recording the first data and the file names in a log which is capable of storing a plurality of the errors.

10. The method as in claim 9 wherein the method further comprises:
presenting a user interface which is configured to present the file names to a user.

11. The method as in claim 10 wherein the presenting is in response to at least one of (a) a user request or (b) an accumulation of a certain number of errors in the log.

12. The method as in claim 9 wherein the user interface comprises a preference interface to allow a user to specify options for how the errors are presented.

13. A data processing system comprising:
means for collecting first data identifying at least one error in performing at least one of reading or writing data to a storage device;
means for determining, though an association between the first data and file identifier, a set of files which are effected by the at least one error.

14. A machine readable medium storing executable program instructions comprising:
a file system software component configured to maintain an association between data which specify portions of physical media of a storage device and file identifiers of files having file names specifiable by a user;
an operating system (OS) kernel operatively coupled to the file system software component, the OS kernel being configured to act as an operating system for a data processing system which is coupled to the storage device and being configured to collect first data identifying at least one error in performing at least one of reading or writing data to the storage device, and wherein the file system software component is configured to determine, through the association, a set of file names which are effected by the errors.

15. The machine readable medium as in claim 14 wherein the OS kernel is configured to collect the first data automatically as a background process while the data processing system is being operated by a user's use of foreground processing, and wherein the first data specifies at least one of addresses and blocks associated with physical media of the storage device, and wherein the OS kernel is configured to collect the first data without requiring the user's request for it.

16. The medium as in claim 15 wherein at least one of the OS kernel and the file system component is configured to record the set of file names in a log which is capable of storing a plurality of the errors.

17. The medium as in claim 16 wherein at least one of the OS kernel and the file system software component is configured to present a user interface which presents the set of file names to the user.

18. The medium as in claim 17 wherein the user interface (UI) is presented without the user's request for the UI.

19. The medium as in claim 17 further comprising:
a file system user interface software component operatively coupled to the file system software component, the file system user interface component being configured to present a preference interface to allow a user to specify options for how the errors are presented.

20. The medium as in claim 17 wherein at least one of the OS kernel and the file system software component initiates the presenting of the UI.

21. A machine readable medium storing executable program instructions which cause a data processing system to perform a method comprising:
scheduling, by an operating system (OS) kernel, system tasks and user application tasks, the OS kernel causing the collecting of first data identifying, through addresses or blocks associated with portions of physical media of a storage device, a set of errors determined in performing at least one of reading or writing data to the storage device, the collecting being initiated without user request by the OS kernel and being performed as a system task while the user causes at least a portion of the user application tasks;
maintaining, by a file system software component, an association between the addresses or blocks and file identifiers for files of the user, the association being used by the file system software component to allow access to the files stored on the storage device;
maintaining a log, though the use of the association, of a set of file identifiers which specify a set of files which are effected by the set of errors, the log being capable of being presented to the user through a user interface as a list of user specified files for the set of files.

22. The medium as in claim 21 wherein the method further comprises:
presenting the user interface to the user; and
wherein the collecting is performed as a background task while the user application tasks are performed.

23. The medium as in claim 21 wherein the reading or writing of data to the storage device is caused by one of the user application tasks executing on the data processing system.

24. The medium as in claim 23 wherein the list of user specified names is automatically maintained as a system initiated task which operates in the background.

25. A machine readable medium storing executable program instructions which cause a data processing system to perform a method comprising:
detecting at least one error in file system metadata for a storage device, the detecting being performed automatically while the data processing system is capable of allowing a user to cause execution of at least one user application process;
storing state information automatically in response to the detecting of the at least one error, wherein the state information specifies that upon next mounting of the storage device, the data processing system will automatically cause the running of a file system check of the file system metadata.

26. The medium as in claim 25 wherein the storing of the state information comprises marking a volume which has files described by the file system metadata, the marking indicating that there is the at least one error.

27. The medium as in claim 26 wherein the detecting occurs at runtime of the data processing system, and wherein during runtime, a file is capable of being modified and the file system metadata is capable of being modified in response to modifying the file.

28. The medium as in claim 27 wherein the file system check includes a check of at least consistency of the file system metadata.

29. The medium as in claim 28 wherein the file system check is performed on the storage device which is a boot volume of the data processing system.

30. The medium as in claim 28 wherein the detecting is performed by one of a file system software component or an operating system software kernel.

31. The medium as in claim 28, wherein the method further comprises:
verifying, on the next mounting of the storage device, whether the file system metadata needs to be corrected and if it does, attempting to correct the file system metadata.

32. The medium as in claim 31 wherein if the attempting to correct fails then the method further comprises:
mounting the storage device in a read only mode.

33. A machine implemented method comprising:
detecting at least one error in file system metadata for a storage device, the detecting being performed automatically while a data processing system is capable of allowing a user to cause execution of at least one user application process;
storing state information automatically in response to the detecting of the at least one error, wherein the state information specifies that upon next mounting of the storage device, the data processing system will automatically cause the running of a file system check of the file system metadata.

34. The method as in claim 33 wherein the storing of the state information comprises marking a volume which has files described by the file system metadata, the marking indicating that there is the at least one error.

35. The method as in claim 34 wherein the detecting occurs at runtime of the data processing system, and wherein during runtime, a file is capable of being modified and the file system metadata is capable of being modified in response to modifying the file.

36. The method as in claim 35 wherein the file system check includes a check of at least consistency of the file system metadata.

37. The method as in claim 36 wherein the file system check is performed on the storage device which is a boot volume of the data processing system.

38. The method as in claim 36 wherein the detecting is performed by one of a file system software component or an operating system software kernel.

39. The method as in claim 36, wherein the method further comprises:
verifying, on the next mounting of the storage device, whether the file system metadata needs to be corrected and if it does, attempting to correct the file system metadata.

40. The method as in claim 39 wherein if the attempting to correct fails then the method further comprises:
mounting the storage device in a read only mode.

41. A data processing system comprising:
means for detecting at least one error in file system metadata for a storage device, the detecting being performed automatically while the data processing system is capable of allowing a user to cause execution of at least one user application process;
means for storing state information automatically in response to the detecting of the at least one error, wherein the state information specifies that upon next mounting of the storage device, the data processing system will automatically cause the running of a file system check of the file system metadata.

42. A machine readable medium storing executable program instructions comprising.
a file system software component configured to maintain a file system metadata which includes data about files stored on a storage device which is to be used with a data processing system;
an operating system (OS) kernel operatively coupled to the file system software component, the OS kernel being configured to act as an operating system for the data processing system, wherein at least one of the OS kernel and the file system software component are configured to store state information automatically in response to detecting of at least one error in the file system metadata, wherein the state information specifies that upon next mounting of the storage device, the data processing system will automatically cause the running of a file system check of the file system metadata.

43. The medium as in claim 42 wherein the detecting is performed automatically as a background process while the data processing system is capable of allowing a user to cause execution of at least one user application process and wherein the state information marks the storage device to indicate that there is the at least one error in the file system metadata.

44. The medium as in claim 43 wherein the detecting occurs at runtime of the data processing system, and wherein during runtime, a file is capable of being modified and the file system metadata is capable of being modified in response to modifying the file.

45. The medium as in claim 44 wherein the file system check includes a check of at least consistency of the file system metadata.

46. The medium as in claim 45 wherein the file system check is configured to be performed on the storage device which is a boot volume of the data processing system.

47. The medium as in claim 45 wherein the file system software component is configured to perform the detecting of the at least one error in the file system metadata.

48. The medium as in claim 45 wherein the OS kernel is configured to verify, on the next mounting of the storage device, whether the file system metadata needs to be corrected and if it does, to attempt to correct the file system metadata.

49. The medium as in claim 48 wherein the OS kernel is configured to mount the storage device in a read only mode if the attempt to correct the file system metadata fails.
